(19) United States
(12) Patent Application Publication
(10) Pub. No.: US 2025/0313276 A1
(43) Pub. Date: Oct. 9, 2025

(54) STRUCTURE FOR REINFORCING STIFFNESS OF REAR FLOOR OF VEHICLE

(71) Applicants: Hyundai Motor Company, Seoul (KR); Kia Corporation, Seoul (KR)

(72) Inventor: Deok-Hwa Hong, Hwaseong-si (KR)

(21) Appl. No.: 18/961,839

(22) Filed: Nov. 27, 2024

(30) Foreign Application Priority Data
Apr. 3, 2024 (KR) 10-2024-0045240

(51) Int. Cl. B62D 25/20; B62D 25/02

(52) U.S. Cl. CPC B62D 25/2009; B62D 25/025

(57) ABSTRACT

A structure for reinforcing stiffness of a rear floor of a vehicle can include a center floor panel arranged under an interior of a vehicle, a rear floor panel, of which a front end can be fastened to a rear end portion of the center floor panel, and a plurality of intermediate members extending in a width direction of the vehicle, fastened to an upper surface of the rear floor panel, and arranged to be spaced apart from each other along a lengthwise direction of the vehicle.

### CROSS-REFERENCE TO RELATED APPLICATIONS

This application claims the benefit of and priority to Korean Patent Application No. 10-2024-0045240, filed on Apr. 3, 2024, which application is hereby incorporated herein by reference in its entirety.

### TECHNICAL FIELD

The present disclosure relates to a structure for reinforcing stiffness of a rear floor of a vehicle.

### BACKGROUND

A cargo space for storing various items can be formed in a vehicle.

For example, referring to FIG. 1, in a vehicle 100 such as a pickup truck, a cargo space is formed under a seat 131 in a second row, and a seat cushion of the seat 131 in the second row can be flipped up, thereby providing an upper portion of the cargo space to load and unload items into and out of the cargo space.

In the structure of the vehicle as illustrated in FIG. 2, a center floor panel 111 and a rear floor panel 112, which is located at a rear side of the center floor panel 111 and is located higher than the center floor panel 111, can be arranged and joined in a lengthwise direction of the vehicle 100. By machining a portion near a front end portion of the rear floor panel 112 to form a partition wall protruding upward, a rear portion of the partition wall may be used as the cargo space.

In such a structure of a vehicle body of the vehicle 100, side sills (not shown) for supporting both sides of a lower portion of the vehicle 100 can be provided at both sides of the center floor panel 111. In FIG. 2, side sill inners 113 and side seal reinforcement members 113a of the side sills are illustrated. Wheel houses 112a can be formed at both sides of the rear floor panel 112 to accommodate wheels of the vehicle 100. Rear side members 114 can be provided at both sides of the rear floor panel 112 in a lengthwise direction of the vehicle 100 to reinforce stiffness of the rear floor panel 112.

The center floor panel 111 and the rear floor panel 112 can be arranged in the lengthwise direction of the vehicle 100 such that when a distance between the first-row and second-row seats of the vehicle 100 increases, the center floor panel 111 may deflect with respect to the rear floor panel 112, causing deformation of the vehicle body.

As illustrated in FIG. 3, a front end of the rear floor panel 112 can be not supported by any portion of the vehicle body, thereby causing deflection of the front end of the rear floor panel 112 and the center floor panel 111.

The partition wall for forming the cargo space in the rear floor panel 112 has been inevitably vulnerable to side collisions. In recent years, pickup trucks have also been developed to be driven using a power of a battery installed under the center floor panel 111 and the rear floor panel 112. The structure for mounting the battery may be vulnerable to side collisions and may cause damage to the battery in the event of side collisions, leading to secondary damage such as a fire due to the collisions.

### SUMMARY

The present disclosure relates to a structure for reinforcing stiffness of a rear floor of a vehicle, which may improve stiffness of a rear floor of a vehicle where a cargo space is formed.

An embodiment of the present disclosure can address the above-noted issues and can provide a structure for reinforcing stiffness of a rear floor of a vehicle, which may enhance stiffness of a cargo space formed under a second-row seat by employing a reinforcing member supporting the cargo space in width and lengthwise directions of the vehicle.

A structure for reinforcing stiffness of a rear floor of a vehicle according to an embodiment of the present disclosure may include: a center floor panel arranged under an interior of the vehicle; a rear floor panel, of which a front end portion is fastened to a rear end portion of the center floor panel; and a plurality of intermediate members formed in a width direction of the vehicle, fastened to an upper surface of the rear floor panel, and arranged to be spaced apart from each other along a lengthwise direction of the vehicle.

Each of the plurality of intermediate members may have at least one closed cross-section formed therein.

Each of the plurality of intermediate members may include a stiff portion having a closed cross-section formed therein and a cover portion covering the stiff portion.

An upper surface of at least one of the plurality of intermediate members may support a seat of the vehicle.

The rear floor panel, the plurality of intermediate members, and the seat may form a cargo space in which items are stored.

A seat mount, to which the seat is fixed, may be installed on an upper surface of a first intermediate member located most forward in the lengthwise direction of the vehicle among the plurality of intermediate members.

Both end portions of the plurality of intermediate members may be fastened to side sill inners of side sills, respectively.

Rear side members formed in the lengthwise direction of the vehicle may be provided on both sides of the rear floor panel. A second intermediate member, located most rearward in the lengthwise direction of the vehicle among the plurality of intermediate members, may be located further forward than a front end portion of the rear side member.

The structure for reinforcing stiffness of a rear floor of a vehicle may further include a longitudinal member arranged in the lengthwise direction of the vehicle and configured to have a front end portion connected to the first intermediate member located most forward in the lengthwise direction of the vehicle among the plurality of intermediate members.

A rear end portion of the longitudinal member may be connected to a transverse member installed on the rear floor panel in the width direction of the vehicle.

The longitudinal member may intersect with the second intermediate member located most rearward in the lengthwise direction of the vehicle among the plurality of intermediate members.

The longitudinal member may include: a front longitudinal member configured to connect the plurality of intermediate members in the lengthwise direction of the vehicle and located on the upper surface of the rear floor panel; and a rear longitudinal member configured to connect the transverse member with the second intermediate member located most rearward in the lengthwise direction of the vehicle among the plurality of intermediate members.

The longitudinal member may include an upper longitudinal member arranged on the upper surface of the rear floor panel and a lower longitudinal member arranged on a lower surface of the rear floor panel.

A child lower anchor, formed to have a rear end portion fixed to the longitudinal member and a front end portion configured to face the seat of the vehicle, may be installed on an upper surface of the upper longitudinal member to secure a child car seat.

In a structure for reinforcing stiffness of a rear floor of a vehicle, the structure may include: a center floor panel arranged under an interior of the vehicle; a rear floor panel, of which a front end portion is fastened to a rear end portion of the center floor panel; a first intermediate member disposed in a width direction of the vehicle; and a second intermediate member spaced apart from the first intermediate member and arranged at a rear side of the first intermediate member in a lengthwise direction of the vehicle, wherein the second intermediate member is fastened to an upper surface of the rear floor panel, and wherein both end portions of the first and second intermediate members are fastened to side sill inners, respectively.

The second intermediate member may be arranged to be in contact with a vertical surface of a stepped portion formed at a boundary between a cabin and a cargo compartment of the rear floor panel.

Each of the first and second intermediate members can have a stiff portion having a closed cross-section formed therein and a cover portion covering the stiff portion.

The stiff portion can be fastened to an upper surface of the rear floor panel, such that stiffness in the width direction of the vehicle is enhanced at a portion to which the first intermediate member or the second intermediate member is fastened.

The structure can further include a longitudinal member supporting the first intermediate member and the second intermediate member in the lengthwise direction of the vehicle. The longitudinal member can be divided into a front longitudinal member and a rear longitudinal member, and wherein each of the front longitudinal member and the rear longitudinal member can include an upper longitudinal member arranged on the upper surface of the rear floor panel and a lower longitudinal member arranged on a lower surface of the rear floor panel.

With the structure for reinforcing stiffness of a rear floor of the vehicle according to an embodiment of the present disclosure having the above configuration, it can be possible to improve stiffness in the width direction of the vehicle at the cargo space by the first intermediate member and the second intermediate member arranged in front of and behind the cargo space, respectively, and improve stiffness in the lengthwise direction of the vehicle by the longitudinal members arranged in the lengthwise direction of the vehicle to connect the first intermediate member and the second intermediate member.

Using an embodiment of the present disclosure, stiffness of the vehicle in the width and lengthwise directions of the vehicle with respect to the cargo space may be improved, thereby preventing damage to a battery mounted under the center floor panel and the rear floor panel in an electrified vehicle in the event of a side collision.

### BRIEF DESCRIPTION OF THE DRAWINGS

FIG. 1 is a side view of a vehicle according to the related art.

FIG. 2 is an exploded perspective view illustrating an interconnection between a center floor panel and a rear floor panel according to the related art.

FIG. 3 is a side view illustrating a state where deflection occurs in the rear floor panel according to the related art.

FIG. 4 is a perspective view illustrating a structure for reinforcing stiffness of a rear floor of a vehicle according to an embodiment of the present disclosure.

FIG. 5 is an exploded perspective view of FIG. 4 illustrating a structure for reinforcing stiffness of a rear floor of a vehicle according to an embodiment of the present disclosure.

FIG. 6 is a plan view of FIG. 4 illustrating a structure for reinforcing stiffness of a rear floor of a vehicle according to an embodiment of the present disclosure.

FIG. 7 is a bottom view of FIG. 6 illustrating a structure for reinforcing stiffness of a rear floor of a vehicle according to an embodiment of the present disclosure.

FIG. 8 is a schematic side view of FIG. 4 illustrating a structure for reinforcing stiffness of a rear floor of a vehicle according to an embodiment of the present disclosure.

FIG. 9 is a schematic enlarged view of section C of FIG. 8.

FIG. 10 is an enlarged partial perspective view illustrating a child lower anchor being installed on a longitudinal member in the structure for reinforcing stiffness of a rear floor of a vehicle according to an embodiment of the present disclosure.

FIG. 11 is a schematic enlarged view of section D of FIG. 8.

FIG. 12 is a schematic side view illustrating a structure for reinforcing stiffness of a rear floor of a vehicle according to another embodiment of the present disclosure.

FIG. 13 is a partial perspective view of FIG. 12.

FIG. 14 is a partial perspective view illustrating a structure for reinforcing stiffness of a rear floor of a vehicle when viewed from another direction according to another embodiment of the present disclosure.

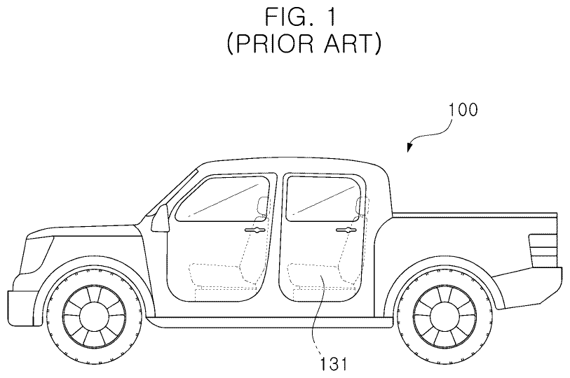

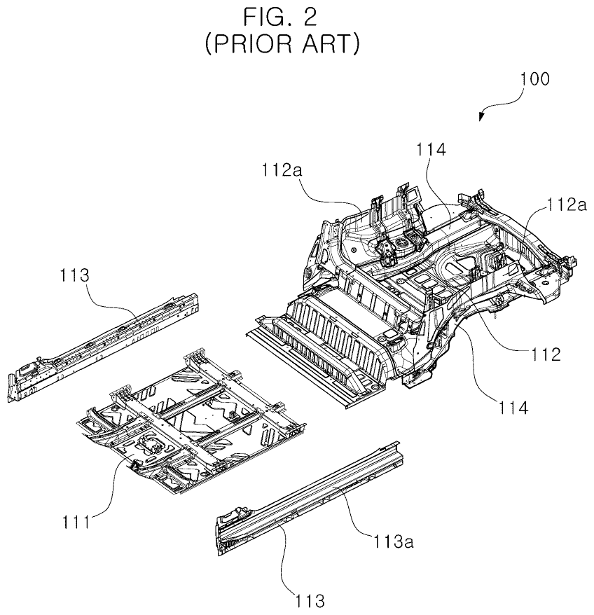

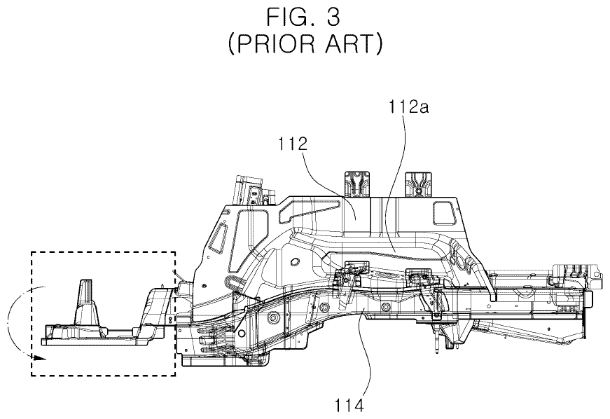

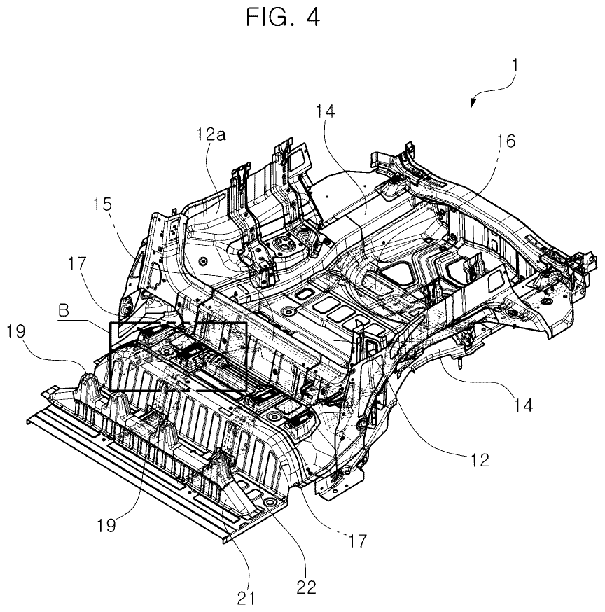

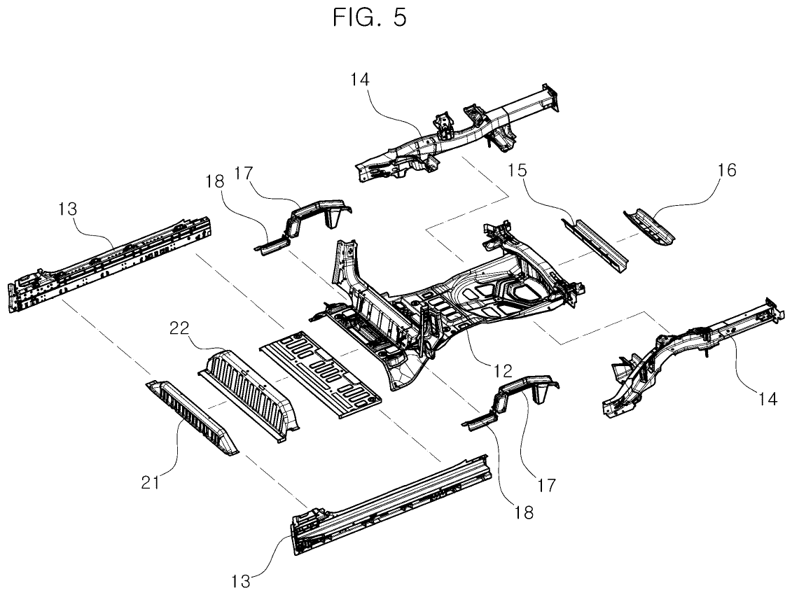

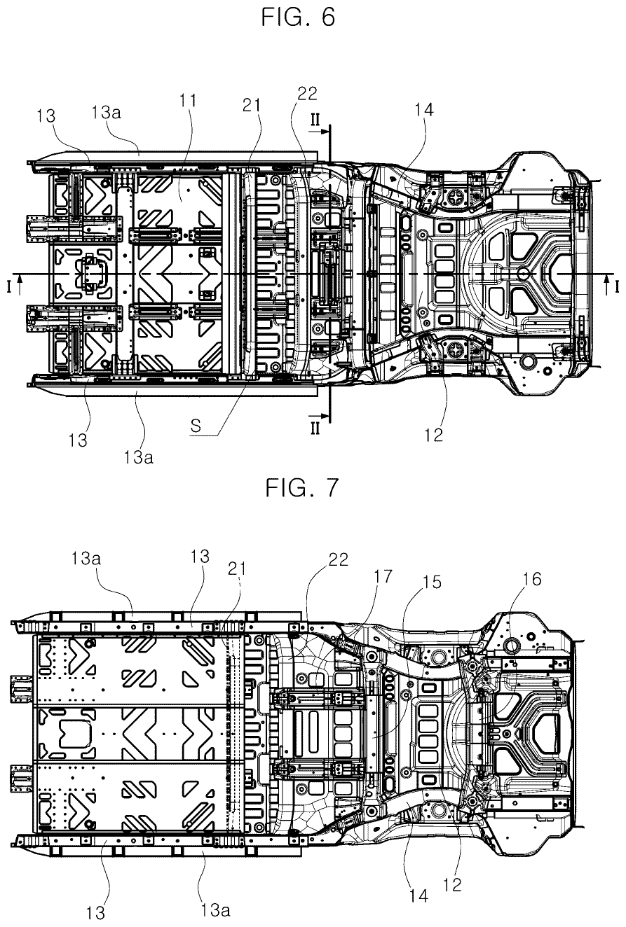

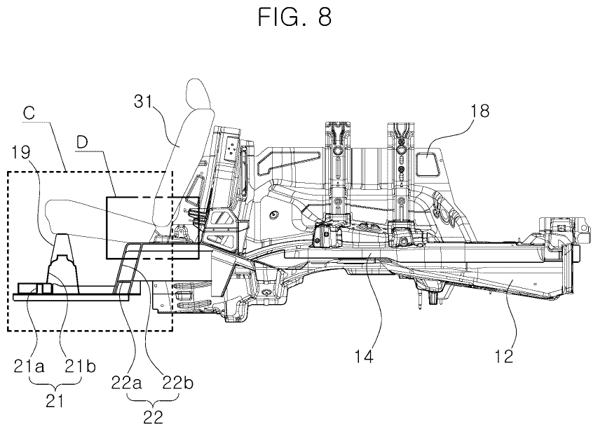

### DETAILED DESCRIPTION OF ILLUSTRATIVE EMBODIMENTS

Hereinafter, a structure for reinforcing stiffness of a rear floor of a vehicle according to example embodiments of the present disclosure will be described in detail with reference to the accompanying drawings.

A structure for reinforcing stiffness of a rear floor of a vehicle according to an example embodiment of the present disclosure may include: a center floor panel 11 arranged under an interior of a vehicle 1; a rear floor panel 12, of which a front end portion can be fastened to a rear end portion of the center floor panel 11; and a plurality of intermediate members 21 and 22 formed in a width direction of a vehicle 1, fastened to an upper surface of the rear floor panel 12, and arranged to be spaced apart from each other along a lengthwise direction of the vehicle 1.

In the vehicle 1, the center floor panel 11 may be arranged at a cabin or a passenger compartment where an occupant can be seated, and the rear floor panel 12 may be arranged at a rear side of the center floor panel 11. If the vehicle 1 is a vehicle such as a pickup truck, the rear floor panel 12 may become a floor of a cargo compartment.

As a front end portion of the rear floor panel 12 can be fastened to the rear end portion of the center floor panel 11, the center floor panel 11 and the rear floor panel 12 may be arranged along the lengthwise direction of the vehicle 1.

Side sills (not shown) for reinforcing stiffness of the lower portion of the sides may be provided at both sides of the center floor panel 11, respectively, in the lengthwise direction of the vehicle 1. The side sills may provide a hollow structure in the lengthwise direction of the vehicle 1 with a side sill outer (not illustrated) and a side sill inner 13. A side seal reinforcement member 13a may be provided inside the side sills to reinforce stiffness of the side sills.

Wheel houses 12a for accommodating wheels, specifically rear wheels, of the vehicle 1, may be formed on the rear floor panel 12. Rear side members 14 can be connected to the side sills and may be provided at both sides of the rear floor panel 12, respectively. The side sills and the rear side members 14 may be arranged at the lower portion of the sides of the vehicle 1 in the lengthwise direction of the vehicle 1, and become a structure that reinforces stiffness of the lower portion of the sides of the vehicle 1.

The rear side members 14 may be arranged on both sides of the vehicle 1 in the lengthwise direction of the vehicle 1 and connected to transverse members 15 and 16 fastened to the rear floor panel 12. That is, both ends of the transverse members 15 and 16 may be connected to the rear side members 14, respectively. The transverse members 15 and 16 may be provided in plural and arranged to be spaced apart from each other along the lengthwise direction of the vehicle 1. For example, the transverse members 15 and 16 may be a front transverse member 15 and a rear transverse member 16 located at the rear of the front transverse member 15.

The plurality of intermediate members 21 and 22 may be fastened to a front portion of the rear floor panel 12, specifically within a predetermined distance from the front end portion of the rear floor panel 12.

The intermediate members 21 and 22 may be provided in plural and arranged to be spaced apart from each other along the lengthwise direction of the vehicle 1. In the present disclosure, the description will focus on an example where the intermediate members 21 and 22 are composed of a first intermediate member 21 and a second intermediate member 22. The second intermediate member 22 may be arranged adjacent to the front end portion of the rear floor panel 12, and the second intermediate member 22 may be arranged at the rear of the first intermediate member 21. In particular, the rear floor panel 12 may be formed to have a stepped portion at a boundary between the cabin and the cargo compartment such that the floor of the cargo compartment is positioned higher than the floor of the cabin. The second intermediate member 22 may be arranged at a portion where a height of the rear floor panel 12 changes. That is, the second intermediate member 22 may be arranged to be in contact with a vertical surface formed at the stepped portion of the rear floor panel 12.

The first intermediate member 21 and the second intermediate member 22 each may have at least one closed cross-section formed therein. Thus, stiffness in the width direction of the vehicle 1 may be reinforced at a front portion of the rear floor panel 12, for example, at a portion where a seat 31 in a second row of the vehicle 1 is mounted.

The first intermediate member 21 may include a stiff portion 21a having a closed cross-section formed therein. The stiff portion 21a may be fastened to the upper surface of the rear floor panel 12. Thus, stiffness in the width direction of the vehicle 1 may be enhanced at a portion to which the first intermediate member 21 is fastened. A cover portion 21b may be formed over the stiff portion 21a and cover the stiff portion 21a.

Similarly, the second intermediate member 22 may also include a stiff portion 22a having a closed cross-section formed therein. Thus, stiffness in the width direction of the vehicle 1 may be enhanced, by the second intermediate member 22, at a portion to which the second intermediate member 22 is fastened. The second intermediate member 22 may also be provided with a cover portion 22b covering the stiff portion 22a.

Both ends of each of the first intermediate member 21 and the second intermediate member 22 may be fastened to the side sill inners 13, respectively. Lower surfaces of the first intermediate member 21 and the second intermediate member 22 may be fastened to the rear floor panel 12, and both sides of the first intermediate member 21 and the second intermediate member 22 may be fastened to the side sill inners 13, respectively. Thus, the first intermediate member 21 and the second intermediate member 22 may constitute a structure that reinforces stiffness in the width direction of the vehicle 1. A portion where the side sill inner 13 and the rear side member 14 are connected may be located rearward in the lengthwise direction of the vehicle 1 compared to a portion where the second intermediate member 22 is installed. Thus, the second intermediate member 22 may be located further forward than a front end of the rear side member 14.

As stiffness in the width direction of the vehicle 1 is enhanced by the first intermediate member 21 and the second intermediate member 22, the security of the occupant may be improved in the event of a side collision. In an electrified vehicle, by preventing a battery mounted under the vehicle 1 from being damaged from a side collision, a fire caused by damage to the battery may be prevented.

The first intermediate member 21 and the second intermediate member 22 may be each fastened to the upper surface of the rear floor panel 12, over which the seat 31 of the vehicle 1 is mounted. The first intermediate member 21 and the second intermediate member 22 may be fastened to the rear floor panel 12. Thus, the seat 31 in the second row may be mounted on the first intermediate member 21 and the second intermediate member 22, thereby supporting the seat 31 of the second row.

A plurality of seat mounts 19 may be installed to be spaced apart from each other on an upper surface of the first intermediate member 21, and the seat 31 may be installed using the seat mounts 19, thereby absorbing a height difference between the upper surface of the first intermediate member 21 and the seat 31.

A space surrounded by the rear floor panel 12, the first intermediate member 21, the second intermediate member 22, and the seat 31 may provide a cargo space S for storing items. As the first intermediate member 21 and the second intermediate member 22, which are arranged in the lengthwise direction of the vehicle 1, may be arranged to be spaced apart from each other, the space therebetween may be used as the cargo space S.

Longitudinal members 17 and 18 may support the plurality of intermediate members 21 and 22, which can be the first intermediate member 21 and the second intermediate member 22, in the lengthwise direction of the vehicle 1.

The longitudinal members 17 and 18 may be arranged in the lengthwise direction of the vehicle 1. Front end portions of the longitudinal members 17 and 18 may be connected to the first intermediate member 21. Rear end portions of the longitudinal members 17 and 18 may be connected to the front transverse member 15. The front transverse member 15 may be arranged to be spaced a predetermined distance apart from the second intermediate member 22, with the longitudinal members 17 and 18 arranged therebetween, thereby supporting the second intermediate member 22 in the lengthwise direction of the vehicle 1.

The longitudinal members 17 and 18 may be arranged to intersect with the second intermediate member 22. The longitudinal members 17 and 18 may be formed to be divided into a front longitudinal member 18 and a rear longitudinal member 17. The front longitudinal member 18 may be fastened to the rear floor panel 12 so as to connect the plurality of intermediate members, which can be the first intermediate member 21 and the second intermediate member 22, in the lengthwise direction of the vehicle 1. The rear longitudinal member 17 may be fastened to the rear floor panel 12 so as to connect the front transverse member 15 with the second intermediate member 22, which can be the intermediate member 22 located most rearward in the lengthwise direction of the vehicle 1 among the plurality of intermediate members 21 and 22.

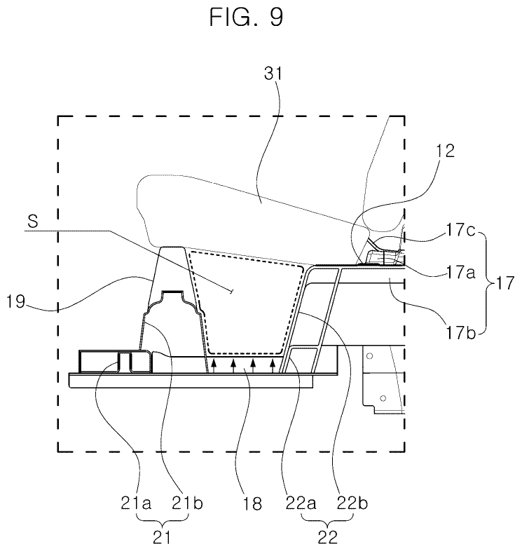

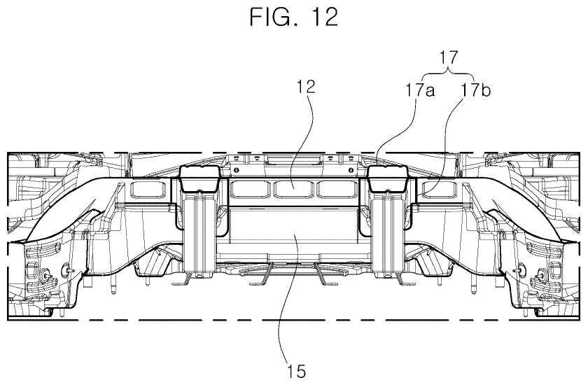

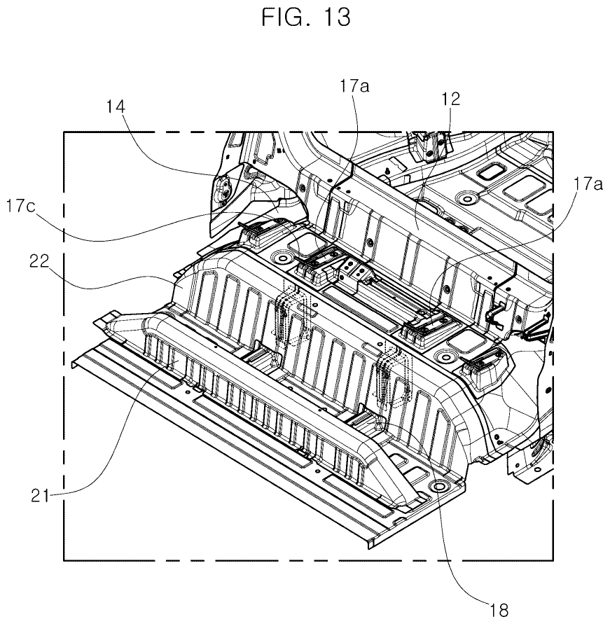

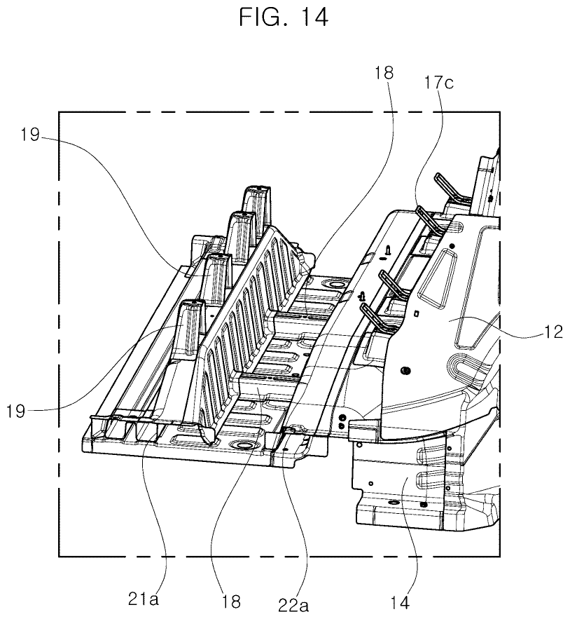

The longitudinal members 17 and 18 may be fastened to the upper and lower surfaces of the rear floor panel 12, respectively. FIGS. 9, 11, and 12 illustrate a configuration in which with the rear longitudinal member 17 composed of an upper longitudinal member 17a and a lower longitudinal member 17b. The upper longitudinal member 17a may be fastened to an upper surface of the rear floor panel 12. The lower longitudinal member 17b may be fastened to a lower surface of the rear floor panel 12. The front longitudinal member 18 is illustrated as being fastened only to the upper surface of the rear floor panel 12, but the front longitudinal member 18 may also be composed of an upper longitudinal member and a lower longitudinal member so as to be fastened to the upper and lower surfaces of the rear floor panel 12, respectively.

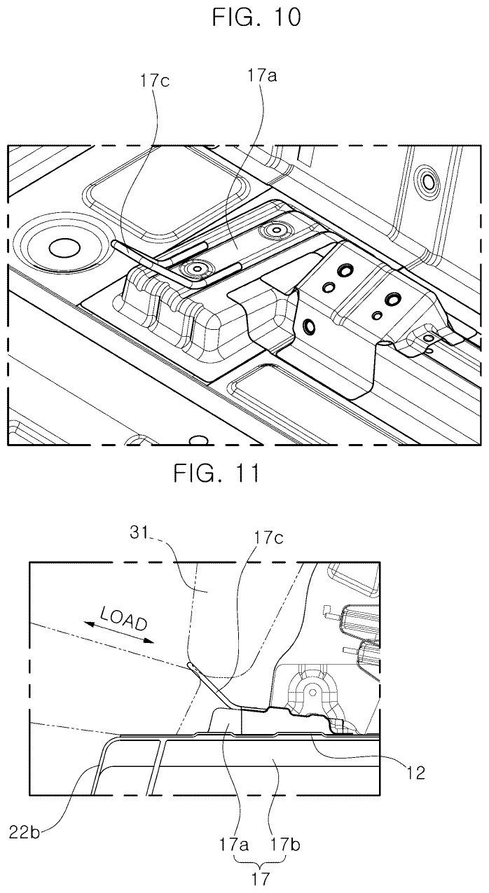

A child lower anchor 17c may be installed on an upper surface of the longitudinal members 17 and 18. For example, the child lower anchor 17c may be formed to have a rear end portion fixed to an upper surface of the rear longitudinal member 17 and a front end portion configured to face the seat of the vehicle. The child lower anchor 17c may be a component for fastening or securing a child car seat. FIGS. 10 and 11 illustrate an example where the child lower anchor 17c is installed on the upper longitudinal member 17a of the rear longitudinal member 17. The child lower anchor 17c may the front end portion formed to be inclined upward, thereby supporting a load generated when the child car seat is mounted in the second row through the child lower anchor 17c.

What is claimed is:

1. A structure for reinforcing stiffness of a rear floor of a vehicle, the structure comprising:
a center floor panel arranged under an interior occupant cabin of the vehicle;
a rear floor panel, of which a rear-floor-panel front end portion is fastened to a center-floor-panel rear end portion of the center floor panel; and
a plurality of intermediate members extending in a width direction of the vehicle, fastened to a rear-floor-panel upper surface of the rear floor panel, and arranged to be spaced apart from each other along a lengthwise direction of the vehicle.

2. The structure of claim 1, wherein each of the plurality of intermediate members includes at least one closed cross-section portion.

3. The structure of claim 2, wherein each of the plurality of intermediate members comprises a stiffener portion having a closed cross-section formed therein and a cover portion covering the stiffener portion.

4. The structure of claim 1, wherein an intermediate-member upper surface of at least one of the plurality of intermediate members supports a seat of the vehicle.

5. The structure of claim 4, wherein the rear floor panel, the plurality of intermediate members, and the seat form a cargo space in which items can be stored.

6. The structure of claim 4, wherein a seat mount, to which the seat is fixed, is installed on a first-intermediate-member upper surface of a first intermediate member located most forward in the lengthwise direction of the vehicle among the plurality of intermediate members.

7. The structure of claim 1, wherein both end portions of the plurality of intermediate members are fastened to side sill inners of side sills, respectively.

8. The structure of claim 7, wherein rear side members formed in the lengthwise direction of the vehicle are provided on both sides of the rear floor panel, and
wherein a second intermediate member of the plurality of intermediate members is located further forward than a rear-side-member front end portion of the rear side member, wherein the second intermediate member is located most rearward in the lengthwise direction of the vehicle among the plurality of intermediate members.

9. The structure of claim 1, further comprising a longitudinal member arranged in the lengthwise direction of the vehicle and configured to have a longitudinal-member front end portion connected to a first intermediate member the plurality of intermediate members, wherein the first intermediate member is located most forward in the lengthwise direction of the vehicle among the plurality of intermediate members.

10. The structure of claim 9, wherein a longitudinal-member rear end portion of the longitudinal member is connected to a transverse member installed on the rear floor panel, wherein the transverse member is extending in the width direction of the vehicle.

11. The structure of claim 9, wherein the longitudinal member intersects with a second intermediate member of the plurality of intermediate members, wherein the second intermediate member is located most rearward in the lengthwise direction of the vehicle among the plurality of intermediate members.

12. The structure of claim 11, wherein the longitudinal member comprises:
a front longitudinal member configured to connect the plurality of intermediate members in the lengthwise direction of the vehicle and located on the rear-floor-panel upper surface of the rear floor panel; and
a rear longitudinal member configured to connect a transverse member with the second intermediate member of the plurality of intermediate members.

13. The structure of claim 9, wherein the longitudinal member comprises:
an upper longitudinal member arranged on the rear-floor-panel upper surface of the rear floor panel; and
a lower longitudinal member arranged on a lower surface of the rear floor panel.

14. The structure of claim 13, further comprising a child lower anchor, wherein the child lower anchor includes a child-lower-anchor rear end portion fixed to the longitudinal member and a child-lower-anchor front end portion configured to face a seat of the vehicle, and wherein the child lower anchor is installed on an upper-longitudinal-member upper surface of the upper longitudinal member and configured to secure a child car seat thereto.

15. A structure for reinforcing stiffness of a rear floor of a vehicle, the structure comprising:
a center floor panel arranged under an interior occupant cabin of the vehicle;
a rear floor panel, of which a front end portion is fastened to a rear end portion of the center floor panel;
a first intermediate member disposed in a width direction of the vehicle;
a second intermediate member spaced apart from the first intermediate member and arranged at a rear side of the first intermediate member relative to a lengthwise direction of the vehicle, wherein the second intermediate member is fastened to an upper surface of the rear floor panel; and
side sill inners, wherein both end portions of the first and second intermediate members are fastened to the side sill inners, respectively.

16. The structure of claim 15, wherein the second intermediate member is arranged to be in contact with a vertical surface of a stepped portion formed at a boundary between the interior occupant cabin and a cargo compartment of the rear floor panel.

17. The structure of claim 15, wherein each of the first and second intermediate members includes a stiffener portion having a closed cross-section formed therein and a cover portion covering the stiffener portion.

18. The structure of claim 17, wherein the stiffener portion is fastened to the upper surface of the rear floor panel, such that stiffness in the width direction of the vehicle is enhanced at a portion to which the first intermediate member or the second intermediate member is fastened.

19. The structure of claim 18, further comprising a longitudinal member supporting the first intermediate member and the second intermediate member in the lengthwise direction of the vehicle.

20. The structure of claim 19, wherein the longitudinal member is divided into a front longitudinal member and a rear longitudinal member, and
wherein each of the front longitudinal member and the rear longitudinal member includes an upper longitudinal member arranged on the upper surface of the rear floor panel and a lower longitudinal member arranged on a lower surface of the rear floor panel.
